(19) United States
(12) Patent Application Publication
(10) Pub. No.: US 2007/0138152 A1
(43) Pub. Date: Jun. 21, 2007

(54) Laser ablation apparatus, processing method, and mask therefor

(75) Inventors: Kenichi Yakushiji, Niigata (JP); Toshio Mandokoro, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/642,090

(22) Filed: Dec. 20, 2006

Related U.S. Application Data
(60) Provisional application No. 60/752,074, filed on Dec. 20, 2005.

(51) Int. Cl. B23K 26/38

(52) U.S. Cl. 219/121.68; 219/121.82

(57) ABSTRACT

According to the invention, a shape with rotational symmetry and minuteness can be easily processed. There is provided a laser ablation apparatus that irradiates laser beams on a work-piece to process the work-piece. The laser ablation apparatus includes a work-piece supporting part that supports the work-piece, an irradiating part that is arranged opposite the work-piece supporting part and irradiates the laser beams of which at least a part are transmitted through a mask on the work-piece, and a rotary driving part that drives the work-piece supporting part and the irradiating part in order to relatively move these parts in a direction of rotation.

### CROSS REFERENCE TO RELATED APPLICATION

The present application claims priority from U.S. Provisional Application No. 60/752,074 filed in U.S. on Dec. 20, 2005, the contents of which are incorporated herein by reference.

### BACKGROUND

1. FIELD OF THE INVENTION

The present invention relates to a laser ablation apparatus, a processing method by laser ablation, and a mask. More particularly, the present invention relates to a processing apparatus for a matrix to be used for manufacturing a lens sheet of which one side has a plurality of lenses formed thereon and a processing method for the matrix.

2. RELATED ART

In recent years, a lens array sheet or a Fresnel lens sheet has been used in a transmission display apparatus or the like represented as a rear projection display. In these lens array sheet and Fresnel lens sheet, a surface structure of a sheet is miniaturized according to fine pitch of lens with high definition of image quality. Moreover, various shapes and arrangements of lenses formed on a sheet surface have been proposed in order to obtain a desired angle of field, for example, in Japanese Patent Application Publication No. 2003-502716. In order to manufacture a sheet having such a surface structure, a matrix of the sheet is processed with high accuracy and in minute detail.

Here, a processing method by laser ablation has been known as a method for finely processing a surface of resin, metal, or the like, for example, in Japanese Patent Application Publication No. 2003-502716 and Japanese Patent Application Publication 2005-131940. Laser ablation is a phenomenon that chemical bond in a material forming a work-piece is cut by absorbing light to be a segment having small molecular weight and thus the segment is evaporated when laser beams with a specific wavelength are irradiated on the work-piece surface.

In the processing method by laser ablation disclosed in Japanese Patent Application Publication No. 2003-502716 and Japanese Patent Application Publication 2005-131940, a matrix such as a lenticular lens sheet cannot be processed in a shape of rotation symmetry such as a concentric shape.

### SUMMARY

To solve the above problem, according to the first aspect of the present invention, there is provided a laser ablation apparatus that irradiates laser beams on a work-piece to process the work-piece. The laser ablation apparatus includes: a work-piece supporting part that supports the work-piece; an irradiating part that is arranged opposite the work-piece supporting part and irradiates the laser beams of which at least a part are transmitted through a mask on the work-piece; and a rotary driving part that drives the work-piece supporting part and the irradiating part in order to relatively move these parts in a direction of rotation. In this way, when processing a surface of the work-piece symmetrically with respect to a rotation, it is possible to easily determine a position and shorten a processing time.

In the laser ablation apparatus, the rotary driving part may drive the irradiating part. In this way, it is possible to process a surface of the work-piece symmetrically with respect to a rotation as the work-piece is fixed.

In the laser ablation apparatus, the rotary driving part may drive the work-piece supporting part. In this way, it is possible to simplify a configuration of the irradiating part because the irradiating part may not include a configuration for performing a rotational transfer.

The laser ablation apparatus may further include a diameter driving part that relatively moves the work-piece supporting part and the irradiating part in a radial direction in a rotational transfer. In this way, it is possible to effectively process a surface of the work-piece even when processing the work-piece, for example, in the shape of a concentric circle.

In the laser ablation apparatus, the irradiating part may have a laser source for irradiating laser beams, a mirror for changing a direction of radiation of the laser beams irradiated from the laser source, a mask supporting portion for supporting the mask, and an optical system for irradiating the laser beams irradiated from the laser source on the mask and irradiating the laser beams passing through the mask on the work-piece, and the diameter driving part may drive at least the mirror. In this way, since the apparatus drives a light part compared to when driving the whole of the irradiating part, it is possible to improve accuracy of positioning during a movement in a radial direction.

In the laser ablation apparatus, the diameter driving part may further drive at least the mask supporting portion and the optical system. In this way, it is possible to irradiate the laser beams passing through the mask on the work-piece with higher accuracy.

In the laser ablation apparatus, the diameter driving part may further drive at least the laser source. In this way, since a relative position of the mirror, the mask supporting portion, the optical system, and the laser source is not changed, it is possible to stabilize irradiating the laser beams on the mask.

In the laser ablation apparatus, the irradiating part may support a plurality of masks sequentially arranged in a direction of rotation corresponding to steps of processing the work-piece. In this way, since the movement of the mask supporting portion in a direction of rotation can be reduced, it is possible to effectively process a surface of the work-piece with higher accuracy.

In the laser ablation apparatus, the irradiating part may support a plurality of masks arranged radially. In this way, since the movement of the mask supporting portion in a radial direction can be reduced, it is possible to effectively process a surface of the work-piece even when processing the surface, for example, in the shape of a concentric circle.

According to the second aspect of the present invention, there is provided a processing method by laser ablation. The method includes: relatively moving in a direction of rotation a work-piece supporting part for supporting a work-piece and an irradiating part being arranged opposite the work-piece supporting part and for irradiating laser beams of which at least a part are transmitted through a mask on the work-piece; and irradiating the laser beams on the work-piece to process the work-piece. In this way, the invention according to the second aspect can obtain an effect similar to that of the first aspect.

According to the third aspect of the present invention, there is provided a mask for laser ablation for irradiating laser beams on a work-piece to process the work-piece. The mask includes a plurality of mask patterns sequentially arranged in the shape of a circular arc corresponding to steps of processing the work-piece. In this way, since the movement of the mask supporting portion in a direction of rotation can be reduced, it is possible to effectively process a surface of the work-piece with higher accuracy.

The summary does not necessarily describe all necessary features of the present invention. The present invention may also be a sub-combination of the features described above.

### BRIEF DESCRIPTION OF THE DRAWINGS

FIG. 1 is a sectional view and top view showing a configuration of a laser ablation apparatus 100.

FIG. 2 is a view schematically showing steps of ablation-processing a surface of a work-piece by means of a laser ablation apparatus 100.

FIG. 3A is a top view showing a photo mask 50 and FIG. 3B is a top view showing a photo mask 150.

FIGS. 4A and 4B are views exemplary showing a curved pattern formed on a work-piece.

FIGS. 5A and 5B are views schematically showing another method of ablation-processing a surface of a work-piece.

FIG. 6 is a sectional view in which a-a′ cross section of a work-piece in FIG. 5B is seen from a left side of FIG. 5B.

FIGS. 7A and 7B are views showing another example of a groove pattern formed on a work-piece.

FIG. 8 is a sectional view and a top view showing a configuration of a laser ablation apparatus 300.

FIG. 9 is a sectional view and a top view showing a configuration of a laser ablation apparatus 500.

### DESCRIPTION OF EXEMPLARY EMBODIMENTS

The embodiments of the invention will now be described based on the preferred embodiments, which do not intend to limit the scope of the present invention, but just exemplify the invention. All of the features and the combinations thereof described in the embodiment are not necessarily essential to the invention.

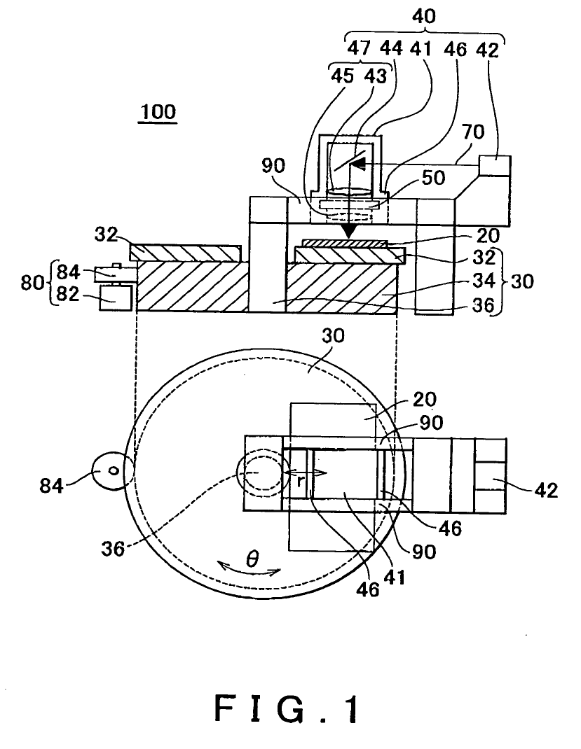

FIG. 1 is a sectional view and top view showing a configuration of a laser ablation apparatus 100 according to an embodiment of the present invention. As shown in FIG. 1, the laser ablation apparatus 100 includes a work-piece supporting part 30, an irradiating part 40, a rotary driving part 80, and a diameter driving part 90.

The work-piece supporting part 30 has a table 32, a bed 34 for supporting the table 32, and a table rotation axis 36. The table 32 fixes a work-piece 20 mounted thereon to hold the work-piece. The bed 34 is joined to a lower face of the table 32 to support the table 32 from its bottom. Moreover, the bed 34 is a substantially cylindrical shape, and an outer circumference thereof abuts on a driving roller 84 of the rotary driving part 80. The bed is rotationally moved by the power of the driving motor 82 along with the table 32 in a direction of rotation (a direction of “θ” in FIG. 1) with a focus on the table rotation axis 36.

The irradiating part 40 has an irradiating head 41, a laser source 42, a mirror 44, a mask supporting portion 46, and an optical system 47. The laser source 42 emits laser beams 70. The mask supporting portion 46 supports a photo mask 50, and is arranged at a side emitting the laser beams 70 in the irradiating head 41. The optical system 47 has a light-source side projector lens 43 and a work-piece side projector lens 45, and optically controls the laser beams 70. The irradiating head 41 and the mask supporting portion 46 are straightly moved by the diameter driving part 90 along with the mirror 44, the optical system 47, and the photo mask 50 in a radial direction (a direction of “r” in FIG. 1). It is preferable that the diameter driving part 90 obtains the positioning of diametrical direction with high precision, for example, by using a direct operated actuator. In this manner, the irradiating head 41 and the mask supporting portion 46 in the laser ablation apparatus 100 can be moved to a position facing a desired position on a surface of the work-piece 20 along with the mirror 44, the optical system 47, and the photo mask 50.

It is preferable that the laser source 42 in the irradiating part 40 according to the present embodiment uses a far-ultraviolet laser as represented by an excimer laser. For example, the excimer laser is a KrF excimer laser of which an output wavelength is 248 nm. The excimer laser is ultraviolet radiation with short wavelength and thus energy per one photon is large. Therefore, when the excimer laser is irradiated on substance, the laser cuts molecular bond in constituent element of substance to form a plasma state in which molecules are scattered. Plasma state is gas phase of atoms that are ionized in the shape of plus and minus, and substance easily flies in all directions when the substance becomes the plasma state. Moreover, substance under this plasma state adversely affects a periphery because the substance is instable as it is, in other words, is chemically active. Thus, it is possible to largely reduce influence on the periphery by the substance by oxidizing the substance under a plasma state using assist gas such as oxygen to promote a reaction to stable gas. When the laser source 42 using such an excimer laser performs an ablation process, molecular bond on the surface of the work-piece 20 that is substance to be processed is instantaneously cut and decomposed. Therefore, an influence of heat on the work-piece 20 can be controlled unlike with a thermal process fusing the surface of the work-piece 20 using a carbon dioxide laser or the like. Therefore, for example, although the work-piece 20 is a thin film, the film is not deformed by heat during an ablation process and thus a fine process is easy.

Moreover, it is preferable that the photo mask 50 according to the present embodiment uses, e.g., quartz glass as a material. Moreover, the optical system 47 uniformly irradiates the laser beams 70 emitted from the laser source 42 on the photo mask 50 and irradiates the laser beams 70 passing through the photo mask 50 on a portion of the work-piece 20 on which an ablation process is performed. For example, the optical system 47 is a pair of convex lenses provided while holding the photo mask therebetween. The laser beams 70 from the laser source 42 are expanded in view of diameter and then are irradiated on the photo mask 50 providing the convex lenses while holding the photo mask therebetween. Therefore, it is possible to prevent the photo mask 50 from being processed by ablation.

Moreover, in the present embodiment, it is preferable that the work-piece 20 provided for an ablation process is formed of polymeric materials having coupling such as C—C, C═C, or C—H. When the laser beams 70 are irradiated on the coupling in the work-piece 20, the coupling is selectively cut by a multiple photon process to become a plasma state consisting of molecules and atoms.

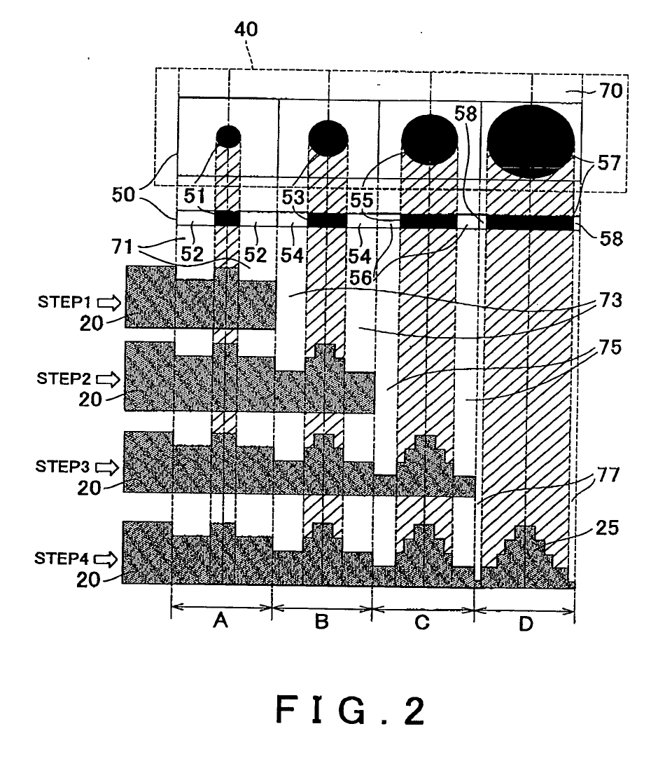

FIG. 2 is a view schematically showing steps of ablation-processing a surface of the work-piece 20 by means of the laser ablation apparatus 100. According to a configuration shown in FIG. 2, four mask patterns having circular shading areas 51, 53, 55, and 57 are linearly arranged on the photo mask 50 according to the size of radius of the shading areas 51, 53, 55, and 57. The shading areas 51, 53, 55, and 57 on the photo mask 50 are set to mask patterns on which a shape of section obtained by cutting the arrangement of a curved pattern 25 of a matrix of a lens array sheet to be obtained with a plane parallel to a principal plane of the curved pattern 25 at a predetermined height is reflected. In this way, the laser ablation apparatus 100 shown in FIG. 1 ablation-processes a surface of the work-piece 20 according to steps of STEP1 to STEP4 shown in FIG. 2, in order to form the curved pattern 25 obtained by disposing a plurality of bowl-type lenses in the shape of a circular arc on the surface of the work-piece 20.

In STEP1, a part of the work-piece 20 moves to station A shown in FIG. 2 by moving the work-piece 20 mounted on a top face of the table 32 of the laser ablation apparatus 100 in a direction of rotation. An exposure area 52 on the photo mask 50 is exposed to the laser beams 70 emitted from the irradiating part 40, and the exposure beams 71 shave off a surface of a portion corresponding to the station A of the work-piece 20.

In STEP2, the shaven portion of the work-piece 20 in STEP1 moves to station B as the work-piece 20 further moves from a position in STEP1 in a direction of rotation. An exposure area 54 on the photo mask 50 is exposed to the laser beams 70 emitted from the irradiating part 40, and the exposure beams 73 further shave off a surface of the work-piece 20. In STEP2, a surface of a portion of the work-piece 20 corresponding to station A is shaven similarly to STEP 1.

In STEP3, as the work-piece 20 further moves from a position in STEP2 in a direction of rotation, the portions of the work-piece 20 respectively shaven at station A and station B respectively move to station B and station C. Subsequently, the exposure area 54 and exposure area 56 on the photo mask 50 are respectively exposed to the laser beams 70 emitted from the irradiating part 40, and these exposure beams 73 and exposure beams 75 further shave off the surface of the work-piece 20. In STEP3, a surface of a portion of the work-piece 20 corresponding to station A is shaven similarly to STEP 1 and STEP2.

In STEP4, as the work-piece 20 further moves from a position in STEP3 in a direction of rotation, the portions of the work-piece 20 respectively shaven at station A, station B, and station C respectively move to station B, station C, and station D. Subsequently, the exposure area 54, exposure area 56, and exposure area 58 on the photo mask 50 are respectively exposed to the laser beams 70 emitted from the irradiating part 40, and these exposure beams 73, exposure beams 75, and exposure beams 77 further shave off the surface of the work-piece 20. In STEP3, a surface of a portion of the work-piece 20 corresponding to station A is shaven similarly to STEP 1 to STEP3.

In this manner, while sequentially moving the work-piece 20 in STEP 1 to STEP 4, the laser ablation apparatus 100 ablation-processes the surface of the work-piece 20 by means of the exposure beams 71, 73, 75, and 77 to which the exposure areas 52, 54, 56, 58 different from one another on the photo mask 50 are respectively exposed, in order to continuously form the curved pattern 25 with the same shape on the surface of the work-piece 20.

In addition, in a configuration shown in FIG. 2, although mask patterns are linearly arranged on the photo mask 50, the arrangement of mask patterns is not limited to this. Moreover, there is not a limit on the number of mask patterns arranged on the photo mask 50, and thus a curved surface can be smoothly formed when these patterns are many. For example, in a microlens array with a lens pitch of about 100 μm, a mask having about hundred mask patterns may be used for a single lens.

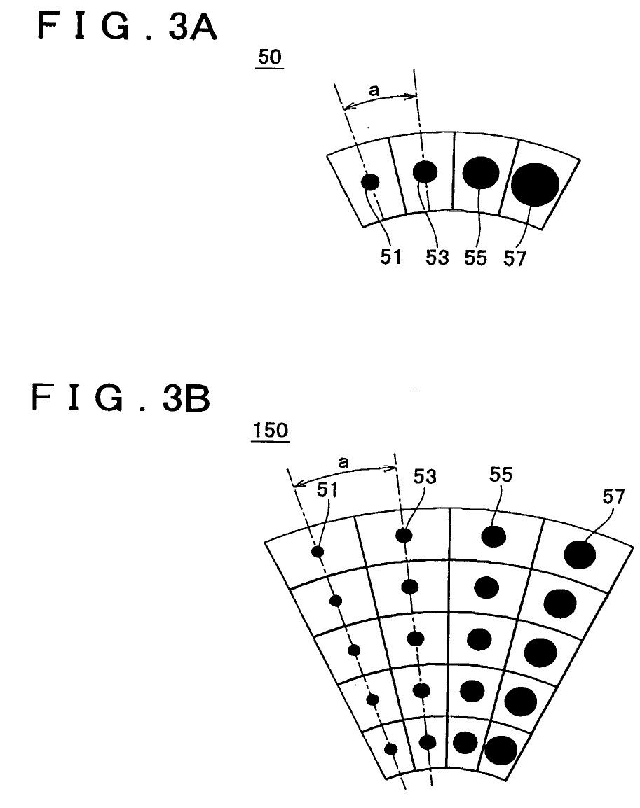

FIG. 3A is a view showing another example of a photo mask 50. In the photo mask 50 shown in FIG. 3A, mask patterns having shading areas 51, 53, 55, and 57 are arranged in the shape of a circular arc according to the size of radius. It is more preferable that the center of circle, in which circular arc parts of inner circumference and outer circumference of the photo mask 50 shown in FIG. 3A respectively become a part of circumference, is same as the center of rotation of the table 32. In this way, the surface of the work-piece 20 can be ablation-processed as the curved patterns 25 are continuously arranged in the shape of a circular arc. Moreover, it is preferable that the irradiating part 40 including the photo mask 50 with such a shape is detachably supported on the photo mask 50 suitable for an ablation process at a position of the irradiating part 40 in a radial direction corresponding to a linear movement in a radial direction by the diameter driving part 90 by means of stocking the photo masks 50 having a plurality of circular arc-shaped outer shapes different from one another. In this way, the surface of the work-piece 20 can be ablation-processed as the curved patterns 25 are continuously arranged in the shape of a plurality of circular arcs that are a concentric circle.

FIG. 3B is a view showing further another example of a photo mask 150. As shown in FIG. 3B, in the photo mask 150, the photo masks 50 having the plurality of circular arc-shaped outer shapes different from one another are continuously adjacent in a radial direction of rotation of the work-piece 20. In this way, when processing the whole surface of the work-piece 20, it is possible to shorten a processing time. Moreover, the surface of the work-piece 20 can be ablation-processed as the curved patterns 25 are continuously arranged in the shape of the plurality of circular arcs that are a concentric circle.

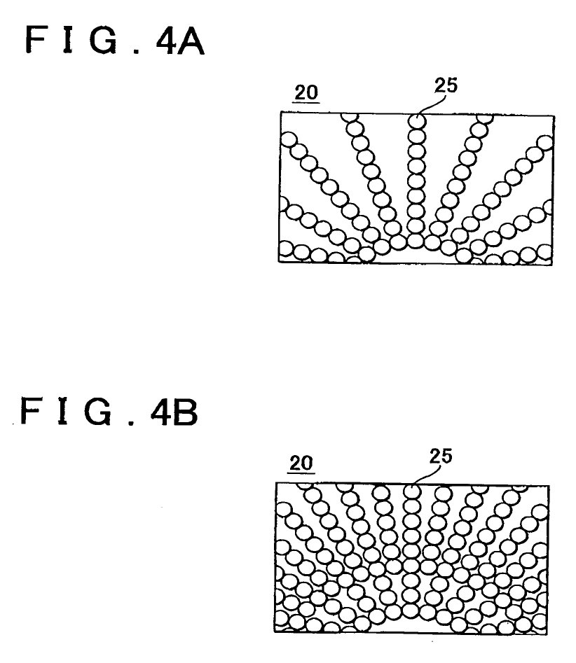

FIG. 4A is a top view showing the curved pattern 25 formed on the work-piece 20 by using the photo mask 50 or the photo mask 150. When the laser ablation apparatus 100 ablation-processes the whole surface of the work-piece 20 by using the photo mask 50 and the photo mask 150 while moving by an interval (an angle) “a” shown one pattern of the mask patterns in a direction of rotation, the work-piece 20 is processed as shown in FIG. 4A. In this case, as shown in the present drawing, an interval between the curved patterns 25 becomes large at a position far from the center of a rotational transfer of the table 32 on the surface of the work-piece 20 as compared to a position near from the center of the rotational transfer.

FIG. 4B is a top view showing the curved pattern 25 formed on the work-piece 20 by using the photo mask 50 or the photo mask 150. Unlike with the case of FIG. 4A, the laser ablation apparatus 100 reduces a moving distance of the work-piece 20 in a direction of rotation to perform ablation when processing the outside in a radial direction during rotating the work-piece 20 as compared to when processing the inside. For example, when processing the outside in a radial direction, the laser ablation apparatus 100 reduces a moving distance of the work-piece 20 in a direction of rotation to be smaller than one pattern of the mask patterns, and ablation-processes a portion on which the curved pattern 25 is not formed on the surface of the work-piece 20, so that the shading areas 51, 53, 55, and 57 on the photo mask 50 or the photo mask 150 are located at a position facing the portion on which the curved pattern 25 is not formed on the surface of the work-piece 20. In this way, as shown in FIG. 4B, it is possible to form the curved pattern 25 on the entire surface of the work-piece 20. Thus, it is possible to produce a microlens sheet using this work-piece 20 as a matrix. In addition, in FIG. 4B, although the work-piece 20 is divided into the inside and the outside using a radial direction as a reference, the work-piece may be further subdivided and processed by gradually changing a moving distance in a direction of rotation.

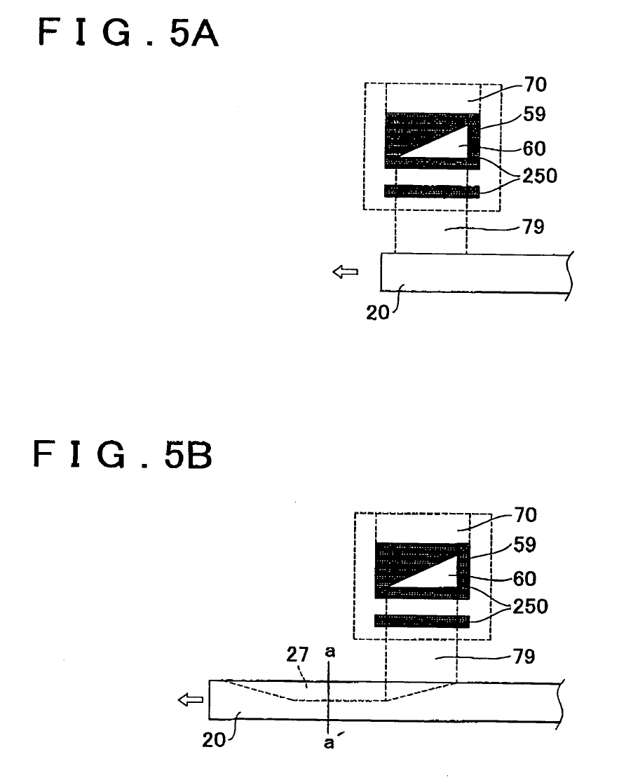

FIGS. 5A and 5B are views schematically showing another method of ablation-processing the surface of the work-piece 20 by means of the laser ablation apparatus 100 shown in FIG. 1. As shown in FIGS. 5A and 5B, in a state that the work-piece 20 moves in a direction of rotation (a direction from a left side to a right side in FIGS. 5A and 5B) in a continuous fashion and at uniform velocity, the irradiating part 40 in the laser ablation apparatus 100 irradiates the laser beams 70 on the surface of the work-piece 20 at a position shown in FIG. 5A. The exposure area 60 on the photo mask 250 is exposed by the irradiated laser beams 70, and the exposure beams 79 shave off the surface of the work-piece 20. Here, when the work-piece 20 moves in a direction of rotation in a continuous fashion and at uniform velocity as described above, a groove pattern 27 is formed on the surface of the work-piece 20 as shown in FIG. 5B.

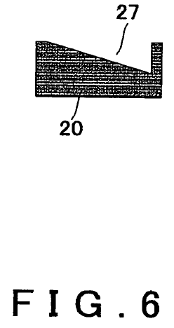

FIG. 6 is a sectional view in which a-a′ cross section of the work-piece 20 in FIG. 5B is seen from a left side of FIG. 5B. A cross sectional shape of the groove pattern 27 is determined by a shape of the exposure area 60 on the photo mask 250, a moving speed of the work-piece 20 in a direction of rotation, and so on. For example, when the shape of the exposure area 60 on the photo mask 250 is a right triangle as shown in FIGS. 5A and 5B and the work-piece 20 moves in a direction of rotation in a continuous fashion and at uniform velocity, the groove pattern 27 becomes a cross sectional shape corresponding to a generally right triangle so that a front side in FIGS. 5A and 5B is deepest, as shown in FIG. 6.

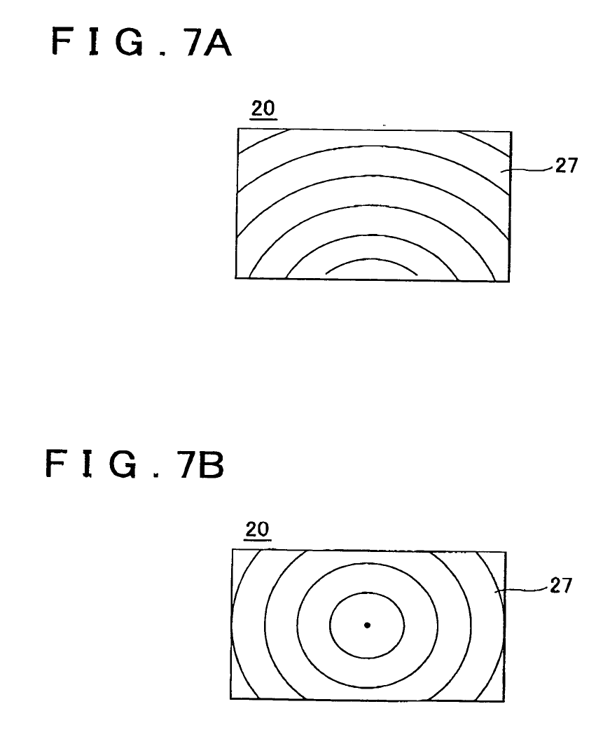

FIG. 7A is a top view showing the groove pattern 27 formed on the work-piece 20 by the photo mask 250 shown in FIGS. 5A and 5B. According to the above method using the photo mask 250 shown in FIGS. 5A and 5B, it is possible to ablation-process the groove pattern 27 forming a plurality of circular arcs in a concentric shape on the surface of the work-piece 20 as shown in FIG. 7A. Therefore, the laser ablation apparatus 100 can easily manufacture a matrix of a Fresnel lens sheet.

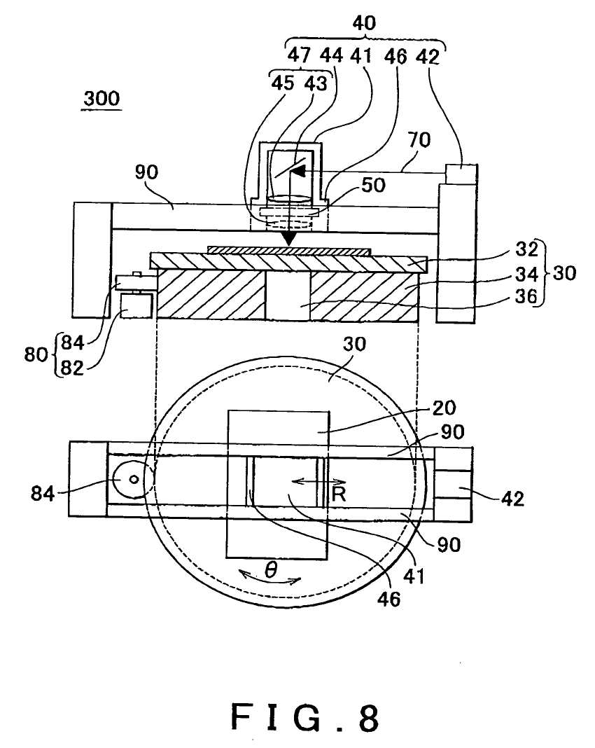

FIG. 8 is a sectional view and a top view showing a configuration of a laser ablation apparatus 300 according to another embodiment. As shown in FIG. 8, an irradiating head 41 and a mask supporting portion 46 in the laser ablation apparatus 300 linearly move in a diametral direction (a direction of “R” in FIG. 8) by means of a diameter driving part 90 along with a mirror 44, an optical system 47, and a photo mask 50. Since another configuration is similar to that of the laser ablation apparatus 100 shown in FIG. 1, their descriptions will be omitted. In addition, in this case, a plurality of photo masks 50 corresponding to length of diameter of an area processed on the work-piece 20 may be arranged in a diametrical direction. In this way, it is possible to further shorten a processing time.

FIG. 7B is a top view showing another groove pattern 27 formed on the work-piece 20 by using the photo mask 250 shown in FIGS. 5A and 5B in place of the photo mask 50 in the laser ablation apparatus 300 shown in FIG. 8. The laser ablation apparatus 300 can ablation-process the groove pattern 27 making a plurality of concentric circles having the center in the work-piece 20 on the surface of the work-piece 20 because the photo mask 250 can move to the center of rotation of the work-piece 20.

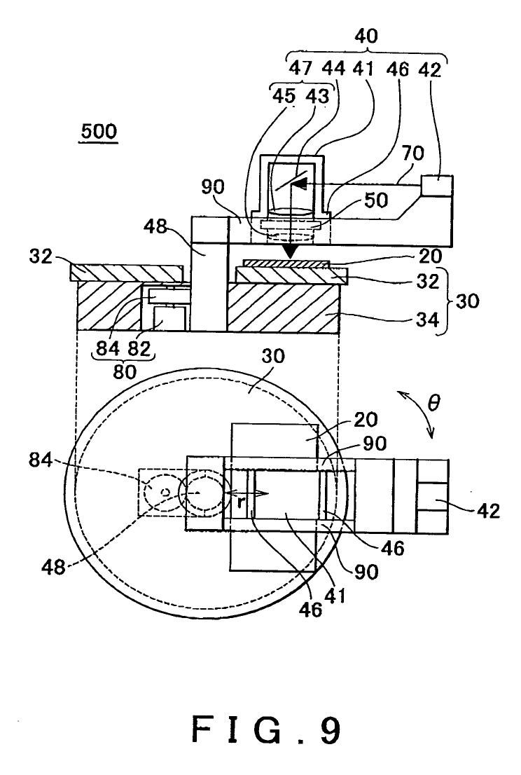

FIG. 9 is a sectional view and a top view showing a configuration of a laser ablation apparatus 500 according to further another embodiment. In the laser ablation apparatus 500 shown in FIG. 9, an irradiating part 40 is a configuration similar to that of the irradiating part 40 in the laser ablation apparatus 100 shown in FIG. 1, and an irradiating head 41 and a mask supporting portion 46 linearly move in a radial direction (a direction of “r” in FIG. 9) by means of a diameter driving part 90 along with a mirror 44, an optical system 47, and a photo mask 50. On the other hand, one end of the diameter driving part 90 in the laser ablation apparatus 500 is supported by an irradiating part rotation axis 48. An outer circumference of the irradiating part rotation axis 48 abuts on a driving roller 84 in a rotary driving part 80, and rotationally moves the irradiating part 40 and the diameter driving part 90 of which one end has a laser source 42 fixed thereon in a direction of rotation (a direction of “θ” in FIG. 1) by means of the power of a driving motor 82. Therefore, since the laser ablation apparatus 500 does not move the work-piece 20, the apparatus can process the surface of the work-piece 20 similarly to the laser ablation apparatus 100 shown in FIG. 1 by means of smaller power.

In the laser ablation apparatus 100, the laser ablation apparatus 300, and the laser ablation apparatus 500, the optical system 47 and the mask supporting portion 46 for supporting the photo mask 50 may be fixedly arranged opposite the laser source 42 at the side to which the laser beams 70 by the laser source 42 are emitted. In this case, the irradiating head 41 on which the mirror 44 is mounted may linearly move in a radial direction or a diametral direction of the work-piece supporting part 30. In this way, since a light portion is linearly moved as compared to when the optical system 47 and the mask supporting portion 46 also move in a radial direction or a diametral direction, it is possible to improve accuracy of positioning in case of a linear movement.

Moreover, alternatively, the irradiating part 40 including the laser source 42 may be driven in an integrated fashion in a radial direction or a diametral direction of the work-piece supporting part 30. In this way, since a relative position between the laser source 42, the mirror 44, the mask supporting portion 46, and the optical system 47 is not changed, it is possible to stabilize the irradiation of the laser beams 70 from the laser source 42 to the photo mask 50.

Although the present invention has been described by of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. A laser ablation apparatus that irradiates laser beams on a work-piece to process the work-piece, comprising:
a work-piece supporting part that supports the work-piece;
an irradiating part that is arranged opposite the work-piece supporting part and irradiates the laser beams of which at least a part are transmitted through a mask on the work-piece; and
a rotary driving part that drives the work-piece supporting part and the irradiating part in order to relatively move these parts in a direction of rotation.

2. The laser ablation apparatus as claimed in claim 1, wherein the rotary driving part drives the irradiating part.

3. The laser ablation apparatus as claimed in claim 1, wherein the rotary driving part drives the work-piece supporting part.

4. The laser ablation apparatus as claimed in claim 1, further comprising a diameter driving part that relatively moves the work-piece supporting part and the irradiating part in a radial direction in a rotational transfer.

5. The laser ablation apparatus as claimed in claim 1, wherein
the irradiating part has a laser source for irradiating laser beams, a mirror for changing a direction of radiation of the laser beams irradiated from the laser source, a mask supporting portion for supporting the mask, and an optical system for irradiating the laser beams irradiated from the laser source on the mask and irradiating the laser beams passing through the mask on the work-piece, and
the diameter driving part drives at least the mirror.

6. The laser ablation apparatus as claimed in claim 5, wherein the diameter driving part further drives at least the mask supporting portion and the optical system.

7. The laser ablation apparatus as claimed in claim 6, wherein the diameter driving part further drives at least the laser source.

8. The laser ablation apparatus as claimed in claim 1, wherein the irradiating part supports a plurality of masks sequentially arranged in a direction of rotation corresponding to steps of processing the work-piece.

9. The laser ablation apparatus as claimed in claim 1, wherein the irradiating part supports a plurality of masks arranged radially.

10. A processing method by laser ablation, comprising:
relatively moving in a direction of rotation a work-piece supporting part for supporting a work-piece and an irradiating part being arranged opposite the work-piece supporting part and for irradiating laser beams of which at least a part are transmitted through a mask on the work-piece; and
irradiating the laser beams on the work-piece to process the work-piece.

11. A mask for laser ablation for irradiating laser beams on a work-piece to process the work-piece, the mask comprising a plurality of mask patterns sequentially arranged in the shape of a circular arc corresponding to steps of processing the work-piece.
